(19) United States
(12) Patent Application Publication
(10) Pub. No.: US 2026/0080887 A1
(43) Pub. Date: Mar. 19, 2026

(54) AUDIO SIGNAL PROCESSING METHOD AND AUDIO PROCESSING DEVICE

(71) Applicant: MEDIATEK INC., Hsinchu City (TW)

(72) Inventors: Chin-Yuan Chang, Hsinchu City (TW); Chia-Wei Wang, Hsinchu City (TW)

(73) Assignee: MEDIATEK INC., Hsinchu City (TW)

(21) Appl. No.: 18/884,127

(22) Filed: Sep. 13, 2024

(51) Int. Cl. G10L 21/034; G10L 21/028; G10L 25/51

(52) U.S. Cl. CPC G10L 21/034; G10L 21/028; G10L 25/51

(57) ABSTRACT

An audio signal processing method applied to an audio signal comprising a first type audio. The audio signal processing method comprises: (a) detecting whether the audio signal comprises second type audio or not; and (b) suppressing a volume of the first type audio but not suppressing a volume of the second type audio when the audio signal comprises the second type audio. An audio signal processing device which can perform the audio signal processing device is also disclosed.

### BACKGROUND

The present application relates to an audio processing method and an audio processing device, and particularly relates to an audio processing method and an audio processing device which can properly suppress an audio signal.

In a related audio processing method, if the audio signal contains ROI (Region Of Interest) audio that needs to be played clearly, non-ROI audio is usually suppressed. For example, when a user is playing a game and another user's voice is coming, the game sound will be suppressed in order to play the voice clearly. However, in such case, non-ROI audio in a time interval much longer than a time interval in which the ROI audio really exist are always suppressed. Accordingly, the dynamic range of the audio signal may be improperly reduced. Besides, if the ROI audio and the non-ROI audio are already mixed, the related audio processing method does do any process to such mixed signal.

### SUMMARY

One objective of the present application is to provide an audio signal processing method which can properly suppress the audio signal.

Another objective of the present application is to provide an audio signal processing device which can properly suppress the audio signal.

One embodiment of the present application provides an audio signal processing method applied to an audio signal comprising a first type audio. The audio signal processing method comprises: (a) detecting whether the audio signal comprises second type audio or not; and (b) suppressing a volume of the first type audio but not suppressing a volume of the second type audio when the audio signal comprises the second type audio.

The audio signal processing method may further comprise: not performing suppressing to the first type audio when the audio signal does not comprise the second type audio.

Moreover, the audio signal processing method may further comprise: separating the first type audio and the second type audio from a mixed audio mixed by the first type audio and the second type audio; and suppressing the volume of the first type audio but not suppressing the volume of the second type audio.

Another embodiment of the present application provides an audio signal processing device, which is applied to an audio signal comprising a first type audio, and comprises an audio detecting device and an audio volume adjusting device. The audio detecting device is configured to detect whether the audio signal comprises second type audio or not. The audio volume adjusting device, configured to suppress a volume of the first type audio but not suppressing a volume of the second type audio when the audio signal comprises the second type audio.

In one embodiment, the audio volume adjusting device does not perform suppressing to the first type audio when the audio signal does not comprise the second type audio.

In another embodiment, the audio detecting device separates the first type audio and the second type audio from mixed audio mixed by the first type audio and the second type audio. Then, the audio volume adjusting device suppresses the volume of the first type audio but not suppressing the volume of the second type audio.

In view of above-mentioned embodiments, the volume of the non-ROI audio contained in the audio signal may be properly suppressed, thus the whole audio signal may have a better dynamic range. Additionally, the volume of the non-ROI audio contained in the audio signal may be properly suppressed, even if the ROI audio and the non-ROI audio are already mixed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating audio signal processing methods according to different embodiments of the present application.

FIG. 3 is a more detail schematic diagram illustrating an audio signal processing method according to one embodiment of the present application.

FIG. 4 is a flow chart illustrating an audio signal processing method according to one embodiment of the present application.

FIG. 5 is a block diagram illustrating an audio signal processing device according to one embodiment of the present application.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices. Further, in following embodiments, game sound and voice sound are used as examples for explaining the present application. However, the methods disclosed in the present application can be used to any other audio signals.

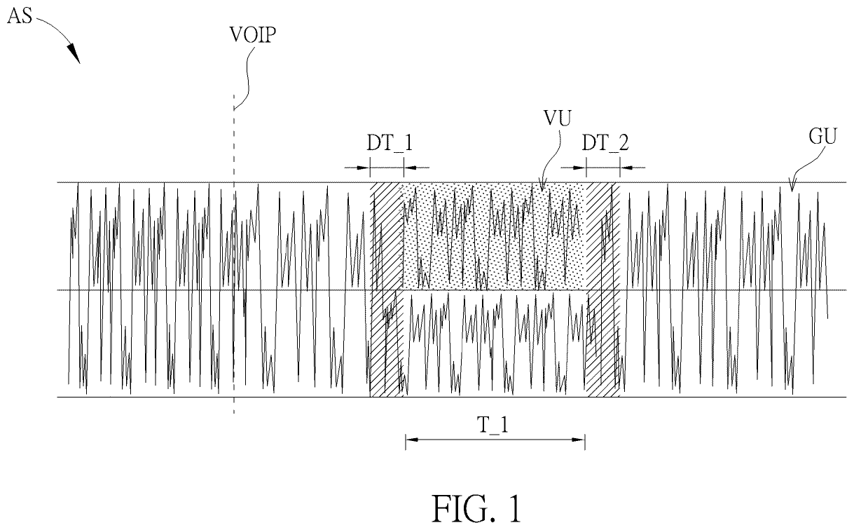

FIG. 1 and FIG. 2 are schematic diagrams illustrating audio signal processing methods according to different embodiments of the present application. As shown in FIG. 1, the audio signal AS comprises game sound GU. The voice sound VU is continuous detected to determine whether it exists in the audio signal AS or not. Various methods can be used to detect the voice sound VU. For example, SPL (Sound Pressure Level) or VAD (Voice Activity Detection) can be used to detect the voice sound VU.

When the voice sound VU is detected, for example, a VOIP (Voice over Internet Protocol) is used thus the voice sound VU is received, a volume of the game sound GU is suppressed but a volume of the voice sound VU is not suppressed. The volume may be suppressed by decreasing an amplitude of the audio. Specifically, in the embodiment of FIG. 1, the voice sound VU exists in a first time interval T_1 and does not exists in other time intervals. Accordingly, in the embodiment of FIG. 1, the game sound GU not in the first time interval T_1 has a first volume, and the volume of the game sound GU in the first time interval is suppressed to a second volume smaller than the first volume. In other words, when the audio signal AS does not comprise the voice sound VU, the game sound GU is not suppressed.

The operations of suppression may be varied corresponding to different embodiments. For example, in one embodiment, the volume of the game sound GU is suppressed when the audio signal comprises the voice sound VU and when the volume of the game sound GU is above a volume threshold. In such embodiment, the volume of the game sound GU is not suppressed when the audio signal comprises the voice sound VU but the volume of the game sound GU is below the volume threshold.

Please refer to FIG. 1 again, in the embodiment of FIG. 1, a first de-bounce time interval DT_1 previous to the first time interval T_1 and a second de-bounce time interval DT_2 after the second time interval T_2 are shown. In the first time interval T_1, the volume of the game sound GU is suppressed from the first volume to the second volume. On the contrary, in the second de-bounce time interval DT_2, the volume of the game sound GU is increased from the second volume to the first volume. The first de-bounce time interval DT_1 and the second de-bounce time interval DT_2 may be larger than a bouncing threshold. In other words, the volumes of the game sound GU do not drastically change in a short period of time, so that users will not feel that the volume of the game sound suddenly drops and raises.

In the embodiment of FIG. 1, the voice sound VU and the game sound GU are not mixed yet. However, the voice sound VU and the game sound GU may already be mixed when the voice sound VU is detected. In such embodiment, the mixed audio which comprises the voice sound VU and the game sound GU is separated first, and then the suppressing step illustrated in FIG. 1 is performed. As shown in the embodiment of FIG. 2, the mixed audio which comprises the voice sound VU and the game sound GU is separated first (e.g., by audio source separation). Next, the volume of the game sound GU is suppressed but the volume of the voice sound VU is not suppressed.

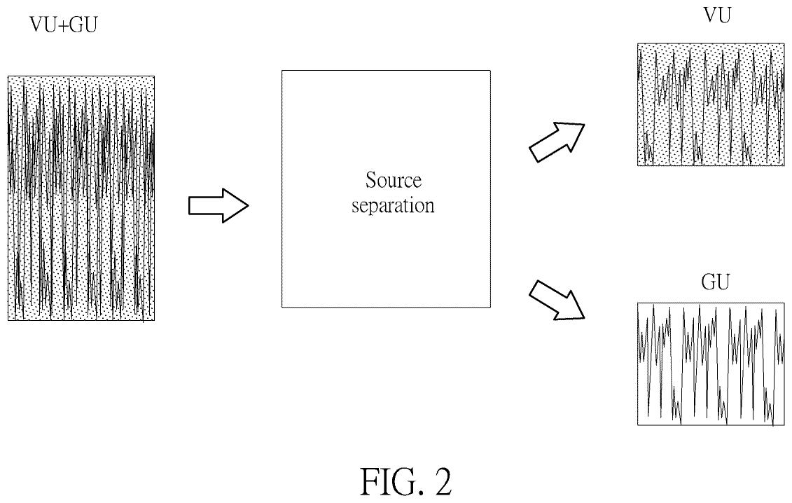

FIG. 3 is a more detail schematic diagram illustrating an audio signal processing method according to one embodiment of the present application. Please note, the flow chart in FIG. 3 is only for explaining and does not mean to limit the scope of the present application. In the embodiment of FIG. 3, the game sound GU and the voice sound VU are already mixed, thus the mixed audio is received. Accordingly, the mixed audio is separated first, and then ROI audio and non-ROI audio are obtained. The ROI audio may represent the audio that need to be played clearly, such as the voice sound VU illustrated in FIG. 1. The non-ROI audio may mean the audio which is desired to be suppressed when the ROI audio exists, such as the game sound GU illustrated in FIG. 1.

In the embodiment of FIG. 3, more than one types of ROI audio are detected. For example, besides the above-mentioned voice sound, musical instrument sound is also detected. The ROI audio may also be music sound or a sound generated by a specific object (e.g., a sound from a machine, a vehicle or an animal). Accordingly, the embodiment in FIG. 3 further comprises an audio detection to determine the type of the ROI audio. After the types of ROI audio are determined, corresponding audio process are performed. The audio process may be, for example, noise filtering, speed adjusting, or volume adjusting, depending on the real requirements. Besides, volume suppressing is performed to the non-ROI audio, as stated in the embodiments of FIG. 1 and FIG. 2. The ROI audio and the non-ROI audio which have been processed may be mixed again to generate a complete audio signal.

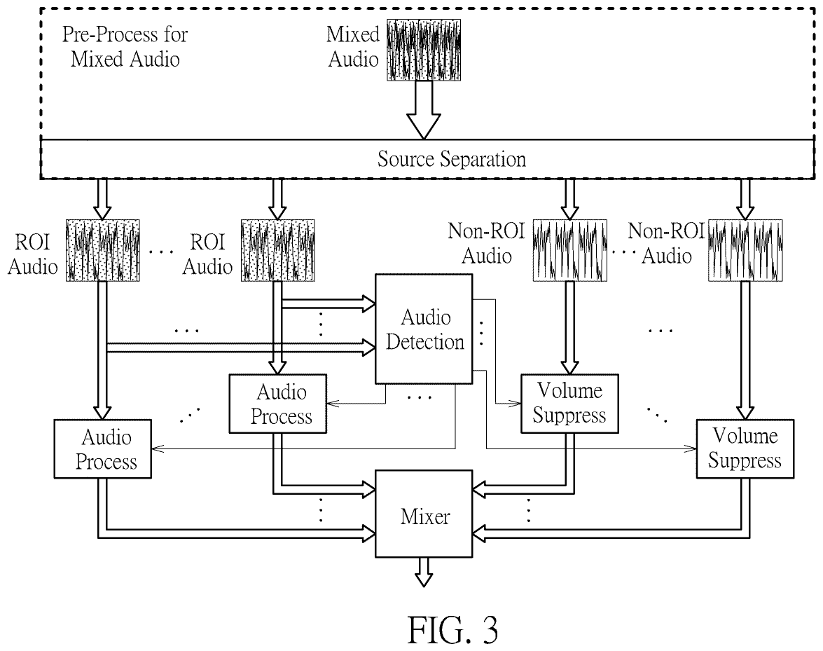

In view of above-mentioned embodiments, an audio signal processing method can be acquired. FIG. 4 is a flow chart illustrating an audio signal processing method according to one embodiment of the present application. The audio signal processing method illustrated in FIG. 4 is applied to an audio signal comprising a first type audio (e.g., the game sound GU) and comprises following steps:

### Step 401

Detect whether the audio signal comprises second type audio (e.g., the voice sound VU) or not.

### Step 403

Suppress a volume of the first type audio but not suppressing a volume of the second type audio when the audio signal comprises the second type audio.

As illustrated in FIG. 3, the type of the ROI audio can be more than one. Accordingly, the audio signal processing method in FIG. 4 may further comprises following steps: detecting whether the audio signal comprises a third type audio or not; and suppressing the volume of the third type audio when the audio signal comprises the third type audio. Specifically, when the audio signal comprises the second type audio, the volume of the first type audio is suppressed but the volume of the second type audio is not suppressed. Also, when the audio signal comprises the third type audio, the volume of the first type audio is suppressed but the volume of the third type audio is not suppressed. Additionally, when the audio signal comprises the second type audio and the third type audio, the volume of the first type audio is suppressed but the volumes of the second type audio and the third type audio are not suppressed.

In the embodiment of FIG. 4, the second type audio may comprise at least one of: voice sound, musical instrument sound, music sound and a sound generated by a specific object. Besides, since the volume adjusting of the first type audio, the first type audio may have a latency sensitivity lower than a latency threshold.

Other detail steps of the audio signal processing method illustrated in FIG. 4 can be acquired in view of above-mentioned embodiments, thus are omitted for brevity here.

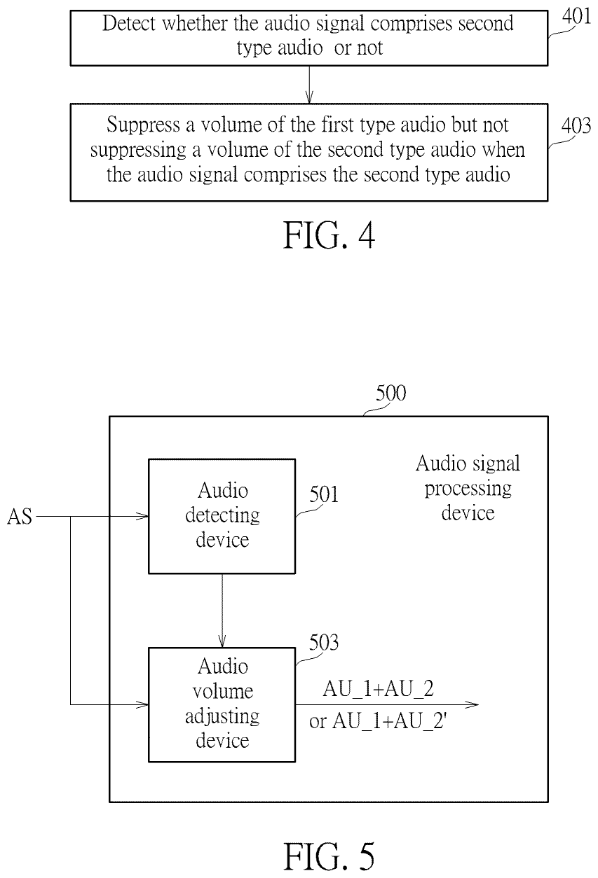

The above-mentioned audio signal processing method may be performed by an audio signal processing device. FIG. 5 is a block diagram illustrating an audio signal processing device 500 according to one embodiment of the present application. As shown in FIG. 5, the audio signal processing device 500 is applied to an audio signal AS comprising first audio AU_1 and comprises an audio detecting device 501 and an audio volume adjusting device 503. The audio detecting device 501 is configured to detect whether the audio signal AS comprises second type audio AU_2 or not.

The audio volume adjusting device 503 is configured to suppress a volume of the first type audio AU_1 but not suppresses a volume of the second type audio AU_2 when the audio signal AS comprises the second type audio AU_2. In such case, the audio volume adjusting device 503 outputs the first type audio AU_1 and the adjusted second type audio AU_2′. As stated in the above-mentioned embodiments, the volume of the first type audio AU_1 is not suppressed when the audio signal AS does not comprise the second type audio AU_2. n such case, the audio volume adjusting device 503 outputs the first type audio AU_1 and the second type audio AU_2.

As stated in the above-mentioned embodiments, if the mixed audio as shown in FIG. 2 is received, the mixed audio is separated first. In such case, the audio detecting device 501 may be configured to separate the mixed audio, but not limited. The audio detecting device 501 and the audio volume adjusting device 503 may be implemented by hardware or software with hardware. For example, the audio detecting device 501 and the audio volume adjusting device 503 may be implemented by a processing circuit executing programs. Additionally, the audio signal processing device 500 may be any kind of electronic device. For example, the audio signal processing device 500 may be a desktop, a mobile device, or a wearable device.

Other detail operations of the audio signal processing device illustrated in FIG. 5 can be acquired in view of above-mentioned embodiments, thus are omitted for brevity here.

In view of above-mentioned embodiments, the volume of the non-ROI audio contained in the audio signal may be properly suppressed, thus the whole audio signal may have a better dynamic range. Additionally, the volume of the non-ROI audio contained in the audio signal may be properly suppressed, even if the ROI audio and the non-ROI audio are already mixed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio signal processing method, applied to an audio signal comprising a first type audio, comprising:
(a) detecting whether the audio signal comprises second type audio or not; and
(b) suppressing a volume of the first type audio but not suppressing a volume of the second type audio when the audio signal comprises the second type audio.

2. The audio signal processing method of claim 1, wherein the step (b) further comprises:
not performing suppressing to the first type audio when the audio signal does not comprise the second type audio.

3. The audio signal processing method of claim 1, wherein the step (b) suppressing the volume of the first type audio when the audio signal comprises the second type audio and when the volume of the first type audio is above a volume threshold.

4. The audio signal processing method of claim 1, wherein the audio signal comprises mixed audio which is mixed by the first type audio and the second type audio, wherein the audio signal processing method further comprises:
separating the first type audio and the second type audio from the mixed audio; and
suppressing the volume of the first type audio but not suppressing the volume of the second type audio.

5. The audio signal processing method of claim 1, further comprising:
detecting whether the audio signal comprises a third type audio or not; and
suppressing the volume of the first type audio but not suppressing the volume of the volume of the third type audio when the audio signal comprises the third type audio.

6. The audio signal processing method of claim 1, wherein the second type audio comprises at least one of: voice sound, musical instrument sound, music sound and a sound generated by a specific object.

7. The audio signal processing method of claim 1, wherein the first type audio has a latency sensitivity lower than a latency threshold.

8. The audio signal processing method of claim 1, wherein the second type audio exists in a first time interval, wherein the audio signal processing method further comprises:
gradually suppresses the volume of the first type audio from a first volume to a second volume in a first de-bounce time interval previous to the first time interval; and
gradually increases the volume of the first type audio from the second volume to the first volume in a second de-bounce time interval after the first time interval;
wherein the first de-bounce time interval and the second de-bounce time interval are larger than a bouncing threshold.

9. The audio signal processing method of claim 1, wherein the step (a) uses SPL (Sound Pressure Level) or VAD (Voice Activity Detection) to detect the second type audio.

10. An audio signal processing device, applied to an audio signal comprising a first type audio, comprising:
an audio detecting device, configured to detect whether the audio signal comprises second type audio or not; and
an audio volume adjusting device, configured to suppress a volume of the first type audio but not suppressing a volume of the second type audio when the audio signal comprises the second type audio.

11. The audio signal processing device of claim 10, wherein the audio volume adjusting device does not perform suppressing to the first type audio when the audio signal does not comprise the second type audio.

12. The audio signal processing device of claim 10, wherein the audio volume adjusting device suppresses the volume of the first type audio when the audio signal comprises the second type audio and when the volume of the first type audio is above a volume threshold.

13. The audio signal processing device of claim 10, wherein the audio signal comprises mixed audio which is mixed by the first type audio and the second type audio,
wherein the audio detecting device separates the first type audio and the second type audio from the mixed audio; and
wherein the audio volume adjusting device suppresses the volume of the first type audio but not suppressing the volume of the second type audio.

14. The audio signal processing device of claim 10, further comprising:
wherein the audio detecting device further detects whether the audio signal comprises a third type audio or not;
wherein the audio volume adjusting device suppresses the volume of the first type audio but not suppressing the volume of the second type audio or the volume of the third type audio when the audio signal comprises the second type audio or the third type audio.

15. The audio signal processing device of claim 10, wherein the second type audio comprises at least one of: voice sound, musical instrument sound, music sound and a sound generated by a specific object.

16. The audio signal processing device of claim 10, wherein the first type audio has a latency sensitivity lower than a latency threshold.

17. The audio signal processing device of claim 10, wherein the second type audio exists in a first time interval,
wherein the audio volume adjusting device gradually suppresses the volume of the first type audio from a first volume to a second volume in a first de-bounce time interval previous to the first time interval;
wherein the audio volume adjusting device gradually increases the volume of the first type audio from the second volume to the first volume in a second de-bounce time interval after the first time interval;
wherein the first de-bounce time interval and the second de-bounce time interval are larger than a bouncing threshold.

18. The audio signal processing device of claim 10, wherein the audio detecting device uses SPL or VAD to detect the second type audio.
